(19) United States
(12) Patent Application Publication
(10) Pub. No.: US 2021/0247082 A1
(43) Pub. Date: Aug. 12, 2021

(54) ENERGY-SAVING AIR CONDITIONER

(71) Applicant: Wing Hong CHAN, Guangdong (CN)

(72) Inventor: Wing Hong CHAN, Guangdong (CN)

(21) Appl. No.: 17/054,171

(22) PCT Filed: Jan. 31, 2019
(86) PCT No.: PCT/CN2019/074129

§ 371 Date: Nov. 10, 2020

(30) Foreign Application Priority Data
Nov. 22, 2018 (CN) 201811405610.4

(51) Int. Cl. F24F 6/04; F24F 5/00; F24F 11/77; F24F 11/46

(52) U.S. Cl. CPC F24F 6/04; F24F 5/0017; F24F 2006/001; F24F 11/46; F24F 11/77

(57) ABSTRACT

An energy-saving air conditioner comprises a conditioner housing (11), a housing top cover (12), a thermal insulation box (16), a thermal insulation box cover (17), a water feed port (18) provided at the thermal insulation box cover (17), and a water evaporative cooler (2). The air conditioner further comprises an ice container (14), a refrigeration element, a speed adjustable electric water pump (35) provided in a housing (13) of the water evaporative cooler (2), and a heat exchanger (39) connecting the speed adjustable electric water pump (35) with the ice container (14). The refrigeration element comprises a refrigeration compressor (31), a refrigerant condenser (32), a refrigerant evaporator (33), and a heat-transfer evaporator metal sheet (34). The installation position of the air conditioner is adjacent to users so as to serve the purpose of energy saving.

### BACKGROUND OF THE INVENTION

The present invention relates to the technical field of air conditioners, and relates to a portable air conditioner that combines cooling air by water evaporation and storing energy using ice cubes, in particular to an energy-saving air conditioner.

Because this energy-saving air conditioner takes energy saving as the primary goal, in addition to considering various methods of energy-saving cooling, it also reduces the waste of cold air on the environment and objects other than the space of the user to reduce wasted energy. According to these objectives, the present invention uses a method of combining water evaporative refrigeration with compressor refrigeration to improve the electrical energy efficiency of refrigeration, and uses a storage compressor to make ice cubes in the air conditioner so that the air conditioner can be installed or moved to the location close to the user, reducing the waste of air-conditioning distribution.

Since the invention of the compressor refrigeration method driven by electricity, people have noticed the high power consumption of the refrigeration device. Since then, many methods have been tried to replace the compressor refrigeration method. The water evaporative refrigeration method is more effective and easy to implement. When water evaporates in the air, the air conditioner absorbs the heat of the air to cool the air, which has a long history. The simplest water evaporative refrigeration method is the Chinese Patent No. CN206281121U in 2017, which is designed using the principle of absorbing water through the capillary tube of the textile, so that the air flows through the wet textile surface to absorb water. The more sophisticated devices comprise various water spray devices to evaporate and atomize the water point into the passing air. For example, the U.S. Pat. No. 5,775,580 in 1998 is an example of spray water evaporative refrigeration.

Water evaporative refrigeration is also limited by its own cooling principle. In humid weather, the cooling capacity is very low. Therefore, the cooling effect can only be achieved when the air humidity is lower. The U.S. Pat. No. 3,182,718 in 1965, the U.S. Pat. No. 3,859,818 in 1975, the U.S. Pat. No. 4,803,849 in 1983, and other patents are all related to air conditioners with compressor refrigeration and water evaporative refrigeration, but these designs are equipped with air dampers so that only one of the methods is used to output cold air to the destination. The U.S. Pat. No. 5,325,681 in 1994 provides a set of water evaporative refrigeration cabinets, which are installed on the air ducts of the compressor refrigeration device. When the outdoor air is dry and the temperature is not too high, only the fan of the compressor refrigeration device is used to draw the outdoor air to pass through the air-permeable curtain with water flowing down. The drawn air is cooled by evaporating water using an air cooling duct, and is then conveyed indoors. As for the combination of water evaporative refrigeration and compressor refrigeration, it was proposed in the U.S. Pat. No. 5,778,696 in 1998 and the U.S. Pat. No. 5,911,745 in 1999 that when the weather is dry and not too hot, water evaporative refrigeration is used alone to supply indoor, but if the weather is not suitable for water evaporative refrigeration, the compressor refrigeration is used to supply indoor. The water evaporates and cools at the same time to supply cold air to cool the roof ceiling interlayer to reduce the load of the compressor refrigeration system. As for the solution of using water evaporative refrigeration and compressor refrigeration at the same time, it was published in the U.S. Pat. No. 4,698,979 in 1987. The solution is that the air is first cooled by water evaporation before being conveyed to the compressor refrigeration evaporator for further cooling.

The invention of the device uses the latent heat of ice as a freezing body, which has a long history. Before the invention of a refrigeration device in ancient times, the ice cubes frozen in winter were placed in the underground chamber, and the heat preservation of the underground soil was used to reduce the melting speed of ice cubes, so that unmelted ice cubes can be used in summer. In modern times, the use of ice cubes for energy storage is mainly due to its lightness and portability. For example, the U.S. Pat. No. 2,802,347 in 1957 has shown that an air blowing fan blows the air in the passenger car through the ice cubes stored in the box to make cold air for use. The U.S. Pat. No. 3,961,496 in 1976 published a set of portable air conditioners provided with ice and cold water storage boxes, small water pumps push the cold water to be conveyed into a set of finned air/cold water heat exchangers, and a built-in electric fan blows through the heat exchanger to output cold air. The U.S. Pat. No. 5,197,301 in 1993 published a set of air conditioners with a metal box for storing ice cubes. The bottom and outside of the box are provided with air ducts, and an electric air blowing fan introduces the air to be cooled to blow cold air through the air ducts. The above refrigeration products with ice energy storage are mainly for the purpose of making the air conditioner portable, so there is no refrigeration device. The U.S. Pat. No. 3,653,221 in 1972 published a set of large air-conditioning systems, which uses a design that combines a compressor refrigeration device with ice energy storage to supply cold air to large buildings. The U.S. Pat. No. 4,294,083 in 1981 and the U.S. Pat. No. 5,090,207 in 1992 are also mainly focused on ice making and ice storage for the design of large air conditioners. The Chinese Patent No. CN1082182A in 1994 published a set of ice-storing air conditioners, and the recent Chinese Patent No. CN205593099U in 2016 published a set of air conditioners using a compressor refrigeration device to make ice.

The cold ice water made of ice cubes is also useful in a water evaporative refrigeration device. The method is to sprinkle ice water on the surface of the air-permeable curtain of the water evaporator to form an ice water film, so that the air flowing through has the further cooling effect, such as the Chinese Patent No. CN200958819Y in 2006 and the Chinese Patent No. CN206094379U in 2017. The design of the former Chinese Patent No. CN200958819Y comprises a set of compression mechanism ice devices, while the Chinese Patent No. CN206094379U takes ice cubes from the outside and puts them in the water tank to make cold water and sprinkle it on the air-permeable curtain of the water evaporator.

The cold water point of the moisture condensed in the air when the evaporator of the refrigeration system cools the flowing air is an auxiliary refrigeration method of adding to the refrigeration device. The auxiliary refrigeration method was published in the U.S. Pat. No. 1,950,344 in 1934, and then in 1940 and 1978, similar patents were also published in the United States, but these patents are used in the same compressor refrigeration system, rather than using condensed cold water for water evaporative refrigeration.

The energy-saving air conditioners on the market now mainly use water to evaporate and cool. The cooling effect is affected by the humidity of the weather. When the humidity is high, the temperature can only be reduced by 1 to 3 degrees Celsius, which wastes energy and makes the room very humid, affecting human health and the life of indoor objects.

### BRIEF SUMMARY OF THE INVENTION

In order to avoid the use of a high-power refrigeration device to match the indoor cooling of large areas and spaces, this energy-saving air conditioner combines several energy-saving air-conditioning manufacturing solutions, reduces the waste of cold air and is designed to be a lightweight energy-saving air conditioner, but at the same time, ensures that the user has a comfortable air-conditioning effect. The energy-saving air conditioner has low manufacturing cost and simple installation, and the installation or placement position is less restricted, so it is widely used by the general public. The air conditioner can not only be used independently, but also can reduce the cooling requirements of large indoor air conditioners or central air conditioners. Using this energy-saving air conditioner can enhance the cooling of less space, and finally achieve the goal of energy saving.

Most of the patent documents published in the past aimed at energy saving were inventions based on the use of water evaporative refrigeration. The design of using compressors to make ice cubes for energy storage and refrigeration is just to save the cost of peak electricity consumption, or to refrigerate when electricity is lacking, and has nothing to do with energy saving. Therefore, with the goal of saving energy and satisfying reasonable refrigeration effects, the following solutions have been established and implemented in combination.

1. Water evaporative refrigeration is used to achieve the energy saving effect.

2. Compressor refrigeration is used to achieve the further cooling effect and control the temperature and humidity of the output cold air.

3. The energy-saving air conditioner is installed or placed in a position close to the user, without being restricted by the indoor structure or layout.

4. The cooling energy is effectively controlled to meet the requirements of users.

In order to overcome the shortcomings of low temperature drop and high humidity of water evaporative refrigeration, the energy-saving air conditioner adds a compressor refrigeration system to further cool and reduce the humidity of the output cold air. However, in order to save cooling energy, only part of the air cooled by water evaporation is further cooled by the compressor refrigeration system. The remaining air cooled by water evaporation is bypassed by the compressor refrigeration elements by a small speed adjustable electric exhaust fan and is directly delivered to the air outlet of the air conditioner, and after being mixed with the air further cooled by the compressor refrigeration system, is delivered to the space of the user. Therefore, by changing the rotation speed of the small speed adjustable electric exhaust fan, the flow ratio of the above two types of air can be changed.

The temperature of the output cold air is affected by the air flow ratio of the above two different cooling methods. In order to simplify the names of the two types of air hereinafter, the air that is cooled by water evaporation and is then further cooled by the compressor refrigeration system is referred to as air A, and the air that is only cooled by water evaporation and is not further cooled by the compressor refrigeration system is referred to as air B. For example, the temperature of air A is TA, and the percentage of the output air flow is R. For example, the temperature of air B is TB, and the percentage of the output air flow is (100-R). The temperature of the output air should be roughly calculated:

{(TA multiplied by R) plus [TB multiplied by (100−R)]} divided by 100

For example, TA=30 degrees Celsius; TB=20 degrees Celsius; R=30, and the temperature of the output air is about 23 degrees Celsius.

The humidity of the output cold air is also affected by the air flow ratio of the above two different cooling methods. For example, the saturated humidity and water content of air A is WA per cubic meter, and the saturated humidity and water content of air B is WB per cubic meter. When the percentage of air A to the output air flow is R, the water content of the output air can also be estimated by the following formula:

{(WA multiplied by R) plus [WB multiplied by (100−R)]} divided by 100

From the calculated water content in air, the relative humidity of the output air can be obtained from the air humidity data table.

The third item of the above solution is to reduce the waste of cold air on the walls, ceilings, and objects in the room. The output cold air should be delivered to the space where the user is located in the shortest distance. To achieve this goal, the energy-saving air conditioner must be able to be placed in the position close to the user without being restricted by the indoor structure, and when supplying cold air, the conditioner will not generate heat and offset the output cold air. Based on this requirement, the present invention adopts the design of ice cube energy storage. When cold air output is not used, the compressor refrigeration system is turned on to make ice cubes and stored in the thermal insulation box. When cold air output is used, the compressor refrigeration system is turned off. Only the ice cubes stored in the thermal insulation box are used to make cold air, and in combination with water evaporation and refrigeration, the cold air is output to the space of the user.

The ice air conditioner system comprises a thermal insulation box installed in the housing of the conditioner, an ice container for storing ice and ice water in the thermal insulation box, a refrigerant evaporator that exchanges energy with the water in the ice container, a speed adjustable electric water pump installed inside or outside the ice container, a finned water/air heat exchanger connected to the circulating cold water pipe of the water pump, and a speed adjustable blowing fan that outputs cold air. In this aspect of the design of this conditioner, the heat preservation efficiency is an important condition for using ice cubes to store energy.

Preferably, the compressor refrigeration system comprises a refrigeration compressor installed in the conditioner housing and a refrigerant condenser connected to the refrigeration compressor, an evaporator installed in the refrigeration container and connected to the refrigerant condenser, and related refrigeration members.

Preferably, the water evaporative cooler of the air conditioner comprises a refrigerating chamber with a water storage container and a water-absorbing wet curtain installed therein. When indoor air enters the water evaporative cooler, it will flow through the surface gaps of the wet curtain wetted by the principle of capillary water absorption, thereby absorbing the water evaporated from the wet curtain, and cooling the air flowing therethrough. The moist air output from the water evaporative cooler is divided into two flows. One flow is a speed adjustable blowing fan that receives the output cold air and sucks into the heat exchanger to further cool the air flowing through the heat exchanger. At the same time, the saturated water in the condensed air forms water points during the cooling process, drops into the heat exchanger and flows into the water storage container of the water evaporative cooler, increasing its cooling effect. The other flow is moist air output by the water evaporative cooler, which is bypassed by the finned water/air heat exchanger by a small speed adjustable electric exhaust fan, enters the speed adjustable blowing fan that outputs cold air, is mixed with the above other further cooled cold air in the speed adjustable blowing fan, and is output to the space where the user is located.

Because the temperature of the ice water is close to zero degrees Celsius before the ice cubes are all melted, if the temperature of the air flowing through the heat exchanger needs to be changed, the speed at which the ice water flows into the heat exchanger must be changed. The ice water heats up due to heat absorption in the heat exchanger at a low ice water flowing speed, and as a result, the temperature of the air output from the heat exchanger is changed, that is, the temperature of air A, and the saturated water humidity of air A also changes.

Since the temperature and humidity of this energy-saving air conditioner can be controlled by a small speed adjustable electric exhaust fan and a speed adjustable electric water pump, the temperature and humidity of the output cold air can be controlled by intelligent electronic components based on theoretical and experimental data. Because this energy-saving air conditioner takes energy saving as the primary goal, the humidity of the output air will be kept within a wide range so that the user can accept it, rather than the most comfortable humidity.

Preferably, the intelligent electronic controller that controls the operation of the air conditioner is installed in the air conditioner housing, and its functions comprise controlling the timing on and off of the compressor refrigeration system, and receiving the data measuring the temperature and humidity installed at the air outlet of the air conditioner. According to a predetermined solution, the speed adjustable electric water pump in the air conditioner for conveying ice water, the small speed adjustable electric exhaust fan in the water evaporator refrigerator, and the speed adjustable blowing fan that delivers cold air to the outside of the conditioner are adjusted. The air conditioner data set by the user can preferably be input via a wireless remote control, but a data input and display panel can also be provided outside the conditioner for use. The user input data comprises the on and off time of the compressor refrigeration system, the output intensity level and time of the cold air. This air conditioner also has pre-programmed intelligent options to simplify the input program of the user. For example, using the programmed sleep intelligent option, during the initial start-up period of the air conditioner, the volume of air output by the cold air is relatively high and the temperature is relatively low. The volume of air output by the cold air will decrease and the temperature will increase slightly. This programming can extend the cooling time of ice cubes.

Compared with the prior art, the beneficial effects of the present invention are as follows: the energy-saving air conditioner combines the structure of water vapor cooling and compressor refrigeration, and can use a small speed adjustable electric exhaust fan, a speed adjustable electric water pump, and a speed adjustable blowing fan to adjust the quality of the cold air output by the energy-saving air conditioner, so as to simultaneously save energy and output cold air with appropriate temperature and humidity to the use space. In addition, because of the cold storage solution with ice, heat dissipation is avoided due to starting the compressor refrigeration system during use. Therefore, the energy-saving air conditioner can be used close to the position of the user, and most of the cooling energy is delivered to the space of the user, reducing waste, thus enhancing the effect of energy saving.

### BRIEF DESCRIPTION OF THE DRAWINGS

FIG. 1 is a working flow chart of an energy-saving air conditioner according to the present invention;

FIG. 2 is a perspective diagram of an energy-saving air conditioner according to the present invention;

FIG. 3 is a rear cross-sectional diagram of an energy-saving air conditioner according to the present invention;

FIG. 4 is an internal structure diagram of an energy-saving air conditioner according to the present invention;

FIG. 5 is a cross-sectional diagram of the lower part of an energy-saving air conditioner according to the present invention, showing the combination of a water evaporative refrigeration element, a cold water refrigeration element, and a blowing fan through which air flows.

### DETAILED DESCRIPTION OF THE INVENTION

The technical solutions in the embodiments of the present invention will be clearly and completely described hereinafter in conjunction with the accompanying drawings in the embodiments of the present invention. Obviously, the described embodiments are only a part of the embodiments of the present invention, rather than all the embodiments. Based on the embodiments of the present invention, all other embodiments obtained by those skilled in the art without creative work shall fall within the protection scope of the present invention.

### Embodiment 1

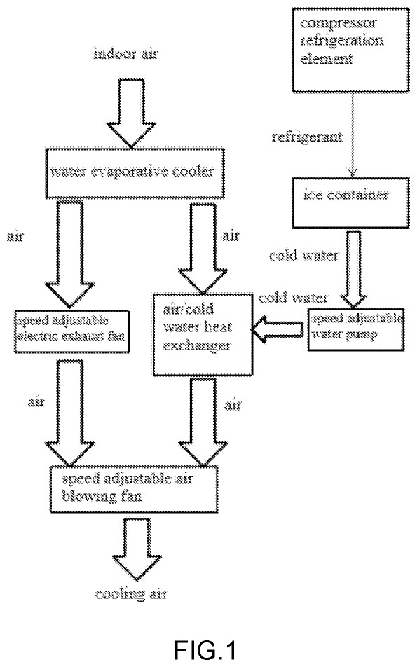

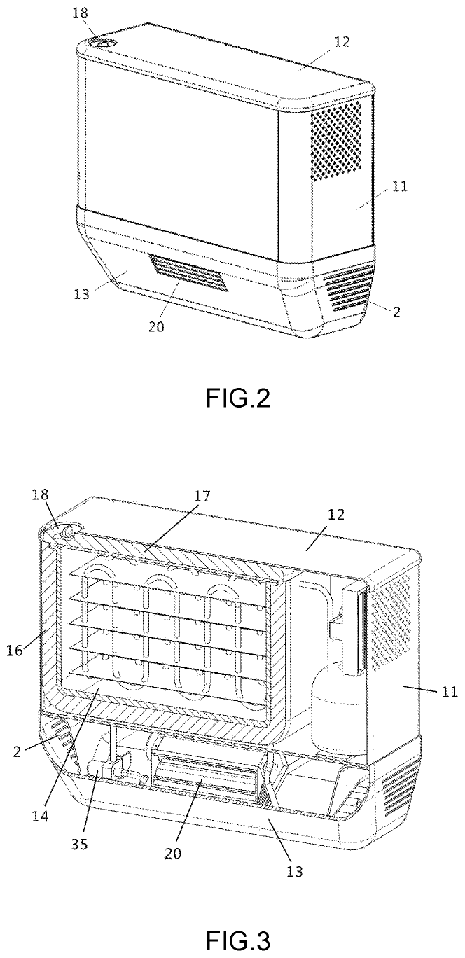

Refer to FIGS. 1-2, which show the working flow of an energy-saving air conditioner, comprising an ice container storing ice cubes and ice water, a refrigeration element that exchanges energy with the ice container, and a speed adjustable electric water pump 35 which outputs circular cold water to the air and cold water heat exchanger 39. When indoor air enters the water evaporative cooler, it will flow through the surface gaps of the wet curtain 40 wetted by the principle of capillary water absorption, thereby absorbing the water evaporated from the wet curtain 40, and cooling the air flowing therethrough. The cooled air is divided into two flows. One flow is sucked into the heat exchanger 39 through the speed regulating blowing fan 38 to further cool the air flowing through the heat exchanger 39. At the same time, the saturated water in the condensed air forms water points during the cooling process, and flows into the water storage container of the water evaporative cooler 2, increasing its cooling effect. The other flow is moist air output by the water evaporative cooler 2, which is bypassed by the heat exchanger 39 by a small speed adjustable electric exhaust fan 41, and enters the speed adjustable blowing fan 38 that outputs cold air. The above two flows of cold air drawn in the speed adjustable blowing fan 38 and mixed in the speed adjustable blowing fan 38 are output to the space where the user is located. A temperature and humidity measuring element is provided at the outlet, and the value is returned to the built-in control electronic component to regulate the temperature and humidity of the air output by the air conditioner.

### Embodiment 2

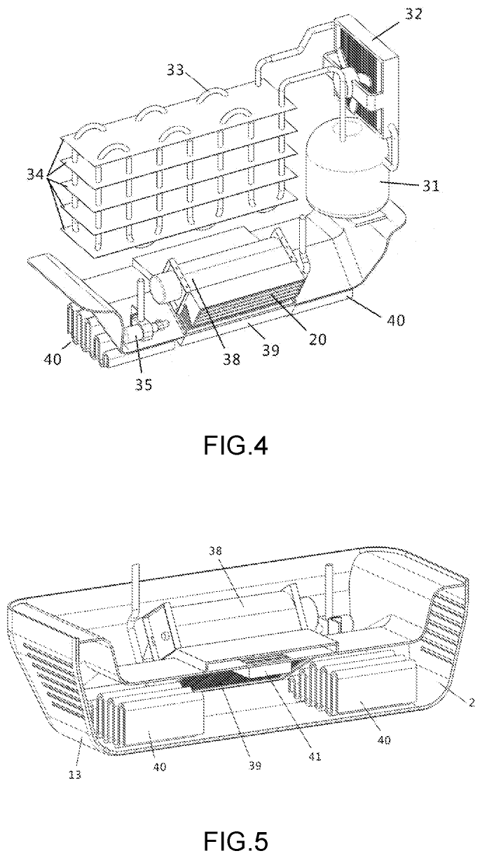

Refer to FIGS. 3-5, which show the internal structure of an energy-saving air conditioner, comprising a conditioner housing 11, a housing top cover 12, a thermal insulation box 16, a thermal insulation box cover 17, a water feed port 18 provided on the thermal insulation box cover, and a water evaporative cooler housing 13, and further comprising an ice container 14 installed in the thermal insulation box 16 and designed to store ice cubes and ice water, a refrigeration element installed in the conditioner housing 11 for energy exchange, a speed adjustable electric water pump 35 provided in a housing of the water evaporative cooler 2, and a built-in intelligent electronic controller (not shown in the figure). The speed adjustable electric water pump 35 for conveying ice water in the air conditioner, the small speed adjustable electric exhaust fan 41 in the water evaporative cooler, and the speed adjustable blowing fan 38 where the cold air is conveyed to the outside of the conditioner can be adjusted by a preset microcomputer programming solution. Within the temperature set by the user and the predetermined humidity range of the air conditioner, the energy-saving effect is improved and the use time of cold storage ice cubes is extended. The speed adjustable electric water pump 35 and the heat exchanger 39 of the ice container 14 are connected to cool the air flowing therethrough. The water absorption wet curtain 40 of the evaporative cooler increases the humidity of the air flowing therethrough. The speed adjustable electric blowing fan 38 is provided. The refrigeration elements comprise a refrigeration compressor 31 and a refrigerant condenser 32 connected to the refrigeration compressor 31, a refrigerant evaporator 33 installed in the refrigeration container 14 and connected to the refrigerant condenser 32, and a heat-transfer evaporator metal sheet 34. The design of ice cube energy storage is used. When the cold air is not used for output, the compressor refrigeration system is turned on to make ice cubes, which are stored in the thermal insulation box 16. When the cold air is used for output, the compressor refrigeration system is turned off, and only the ice cubes stored in the thermal insulation box 16 are used to make cold air, which is output to the space in combination with water evaporation and refrigeration. This product can also be designed as a wall-mounted type or floor-mounted type. The floor-mounted type can add a pulley to the bottom to facilitate movement to a suitable position.

Although the embodiments of the present invention have been shown and described, those skilled in the art can understand that various changes, modifications, substitutions, and variations can be made to these embodiments without departing from the principle and spirit of the present invention. The scope of the present invention is defined by the appended claims and their equivalents.

1. An energy-saving air conditioner, wherein the main structure of the air conditioner comprises a conditioner housing (11), a housing top cover (12), a thermal insulation box (16), a thermal insulation box cover (17), a water feed port (18) provided at the thermal insulation box cover, and a water evaporative cooler (2), wherein the air conditioner further comprises an ice container (14) installed in the thermal insulation box (16) and designed to store ice cubes and ice water, a refrigeration element installed in the conditioner housing (11) for energy exchange, a speed adjustable electric water pump (35) provided in a housing (13) of the water evaporative cooler (2), a heat exchanger (39) connecting the speed adjustable electric water pump (35) with the ice container (14), a water absorption wet curtain (40) of the evaporative cooler, and a small speed adjustable electric air blowing fan (38), and the refrigeration element comprises a refrigeration compressor (31), a refrigerant condenser (32) connected to the refrigeration compressor (31), a refrigerant evaporator (33) installed in the refrigeration container (14) and connected to the refrigerant condenser (32), and a heat-transfer evaporator metal sheet (34).

2. The energy-saving air conditioner according to claim 1, wherein the water evaporative cooler (2) initially cools the drawn air, a part of the air then is further cooled through the heat exchanger (39), the remaining part of the air is sent directly to the outlet (20) of the speed adjustable blowing fan (38) by a small speed adjustable electric exhaust fan (41), is mixed with the further cooled air, and is output to the space where the remaining part of the air is located together with the further cooled air, and the rotating speed of the small speed adjustable electric exhaust fan (41) is changed so as to change the mixing ratio of the above two types of air.

3. The energy-saving air conditioner according to claim 2, wherein the rotation speed of the small speed adjustable electric exhaust fan (41) is adjustable by the electronic components built in the air conditioner to change its exhaust air volume, and finally change the further cooled air flowing through the heat exchanger (39) to be mixed with the air flow of the air passing through the heat exchanger (39), because the temperature and water content of the two types of air are different, the temperature and water content of the mixed air produced will be determined by the flow ratio of the two types of air, and therefore, the rotation speed of the small speed adjustable electric exhaust fan (41) is adjusted to change the temperature and humidity of the cool air output from the energy-saving air conditioner.

4. The energy-saving air conditioner according to claim 1, wherein the rotation speed of the speed adjustable electric water pump (35) is adjustable by the built-in electronic components to change its water discharge, thus changing the exchanged heat of the heat exchanger (39) to change the temperature of the air passing through the heat exchanger (39).

5. The energy-saving air conditioner according to claim 2, wherein when the heat exchanger (39) cools the air, the moisture in the air decreases due to the decrease of the air temperature, the moisture exceeding the saturation humidity will condense into water droplets attached to the metal fins of the heat exchanger (39), and finally the accumulated water droplets fall and are guided to a water storage tank of the water evaporative cooler (2), reducing the water temperature in the tank without wasting cooling energy, and supplementing the water evaporated by the water evaporative cooler (2).

6. The energy-saving air conditioner according to claim 3, wherein when the heat exchanger (39) cools the air, the moisture in the air decreases due to the decrease of the air temperature, the moisture exceeding the saturation humidity will condense into water droplets attached to the metal fins of the heat exchanger (39), and finally the accumulated water droplets fall and are guided to a water storage tank of the water evaporative cooler (2), reducing the water temperature in the tank without wasting cooling energy, and supplementing the water evaporated by the water evaporative cooler (2).

7. The energy-saving air conditioner according to claim 4, wherein when the heat exchanger (39) cools the air, the moisture in the air decreases due to the decrease of the air temperature, the moisture exceeding the saturation humidity will condense into water droplets attached to the metal fins of the heat exchanger (39), and finally the accumulated water droplets fall and are guided to a water storage tank of the water evaporative cooler (2), reducing the water temperature in the tank without wasting cooling energy, and supplementing the water evaporated by the water evaporative cooler (2).
